(19) United States
(12) Patent Application Publication
(10) Pub. No.: US 2004/0024564 A1
(43) Pub. Date: Feb. 5, 2004

(54) Steering position sensor assembly utilizing angular velocity sensor

(76) Inventor: Kenneth J. Baize, Macomb, MI (US)

Correspondence Address: U.S. Docket Administrator, BorgWarner Inc., 3001 West Big Beaver Road, Suite 200, P.O Box 5060, Troy, MI, 48007-5060, US

(21) Appl. No.: 10/208,904

(22) Filed: Jul. 30, 2002

(51) Int. Cl. G01C 9/00

(52) U.S. Cl. 702/151

(57) ABSTRACT

An apparatus and method for providing a data signal representative of the current angular position of the steering wheel and steering wheels of a vehicle utilizes a rotary or angular velocity sensor sensing rotation of the steering column. The angular velocity sensor includes two outputs providing pulses having a distinct phase relationship and a third output which provides a signal at the center or straight ahead position of the steering wheel or column. The pulses and their leading edges are utilized to increment and decrement a counter which provides an indication of angular position. The accuracy of the output may be compared with data with front wheel speed sensors and the center position sensor to ensure continued operating accuracy. A memory device stores the current angular position when the ignition is turned off in order to provide such information when the ignition is turned on.

### BACKGROUND OF THE INVENTION

The invention relates generally to a method and apparatus of sensing angular position of a rotating member and more particularly to a method and apparatus for sensing the angular position of a steering wheel or the steering wheels of a vehicle by utilizing an angular velocity sensor disposed in sensing relationship with the steering column of a motor vehicle.

The sophistication of motor vehicle instrumentation and data utilization continues to increase. Sensors abound in both the internal combustion engine such as throttle position sensors, knock sensors and oxygen concentration sensors and in the chassis where wheel speed sensors and wheel position sensors, to name but two, are commonplace. The electronic devices and software associated with these sensors increasingly control engine, braking and suspension activity and performance.

A subtrend of this sophistication, with the continuing emphasis upon vehicle weight reduction, is the use of a particular sensor, for example, a wheel speed sensor, to provide a signal to both an anti-lock braking system and a traction control system, thus eliminating separate sensors. In fact, the wheel speed data from a single sensor may be utilized to provide data to numerous vehicle operating systems.

As electronic systems are increasingly involved with the real-time control of vehicle dynamics, additional sensors are finding their way into motor vehicles. For example, lateral acceleration sensors and steering angular velocity sensors are increasingly being included to provide additional data to on-board computational systems to control suspension performance and overall vehicle dynamics.

Vehicular control systems utilizing steering wheel angular velocity sensors are disclosed in U.S. Pat. Nos. 4,971,173, 5,984,042, 6,102,151, 6,129,172 and 6,148,948. Whereas the systems disclosed in the foregoing patents utilize steering wheel angular velocity sensors, it is frequently desirable to also have real-time data regarding the current angular position of the steering wheel or steered wheels. It would also be desirable not to require a second, additional sensor to provide such angular position data, but rather utilize a single sensor. The present invention is directed to such an apparatus and method.

### BRIEF SUMMARY OF THE INVENTION

An apparatus and method for providing a data signal representative of the current angular position of the steering wheel or steering wheels of a vehicle utilizes a rotary or angular velocity sensor sensing rotation of the steering column. The angular velocity sensor includes two outputs providing pulse trains having a distinct phase relationship and a third output which provides a signal at the center or straight ahead position of the steering wheel or column. The pulses and specifically their leading edges are utilized to increment and decrement a counter which provides an indication of angular position. The accuracy of the output may be compared with data from front wheel speed sensors and the center position sensor to ensure continued operating accuracy. A memory device stores the current angular position when the ignition is turned off in order to provide such information when the ignition is again activated.

Thus it is an object of the present invention to provide an apparatus for providing a signal representing the current angular position of a vehicular steering wheel from data provided by an angular velocity sensor.

It is a further object of the present invention to provide an apparatus for sensing the angular velocity of a vehicular steering wheel or column and providing real time data regarding the current angular position of the steering column, steering wheel or steering wheels of the vehicle.

It is a still further object of the present invention to provide an apparatus for generating a signal representing the real-time position of a steering wheel or steering column which resets the indicated position when the steering wheel is at 0° rotation, i.e., the vehicle is traveling straight ahead.

It is a still further object of the present invention to provide a method of deriving the real-time angular position of a steering column, steering wheel or steering wheels of a vehicle from an angular velocity sensor associated with or driven by the vehicle steering column.

Further objects and advantages of the present invention will become apparent by reference to following description of the preferred embodiment and appended drawings wherein like reference numbers refer to the same component, element or feature.

### BRIEF DESCRIPTION OF THE DRAWINGS

FIG. 1 is a diagrammatic view of a motor vehicle chassis incorporating a steering angle sensor assembly according to the present invention;

FIG. 2 is a block diagram of the electronic components of a steering angle sensor assembly according to the present invention;

FIG. 3 is a graphic representation of the three outputs of the sensors of a steering angle sensor assembly according to the present invention;

FIG. 4 is a greatly enlarged view of two of the three outputs of the sensors of a steering angle sensor assembly according to the present invention; and

FIG. 5 is a table illustrating the signal outputs and changes of state of the outputs of two of the sensors of a steering angle sensor assembly according to the present invention.

### DESCRIPTION OF THE PREFERRED EMBODIMENT

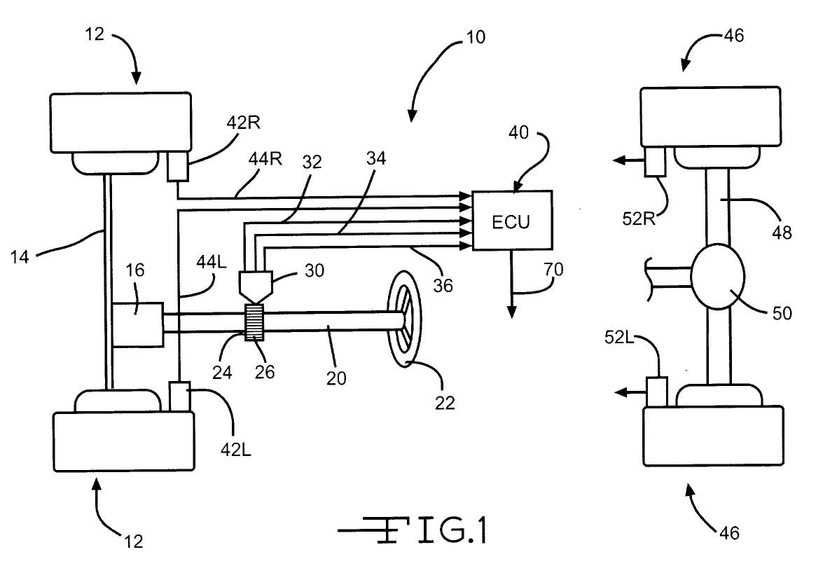

Referring now to FIG. 1, a motor vehicle chassis incorporating a steering angle sensor assembly according to the present invention as illustrated and generally designated by the reference number 10. The motor vehicle chassis 10 includes a pair of front tire and wheel assemblies 12 which are interconnected by a bi-directionally, transversely translating linkage 14 which is driven and positioned by a steering box 16. The linkage 14 and steering box 16 may be one of numerous types of assemblies such as recirculating ball, rack and pinion or any other known assembly which converts the bi-directional rotation of the steering column 20 and steering wheel 22 into corresponding bi-directional transverse translation of the linkage 14 and bi-directional pivoting motion of the front tire and wheel assemblies 12 in accordance with conventional practice. Disposed at a convenient location on the rotating steering column 20 is a tone wheel 24 having a plurality of distinct teeth 26. Disposed in proximate, sensing relationship with the tone wheel 24 and its teeth 26 is a rotary or angular velocity sensor 30. The rotary or angular velocity sensor 30 includes three output lines 32, 34 and 36 which carry three distinct, independent signals which shall be designated Steering 1 or STR 1, Steering 2 or STR 2 and Steering Center or STR C, respectively. The signals are provided to a microprocessor or electronic computation unit (ECU) 40.

The front tire and wheel assemblies 12 also include left and right wheel speed sensors 42L and 42R which provide signals in lines 44L and 44R, respectively, to the electronic computation unit 40.

The chassis 10 also includes rear tire and wheel assemblies 46 which are coupled by half shafts 48 to a rear differential 50. The left and right rear tire and wheel assemblies 46 will also typically include left and right wheel speed sensor assemblies 52L and 52R, respectively, which may be associated with and provide signals to electronic vehicle operating systems such as ABS (anti-lock brake system). It will be appreciated that while the motor vehicle chassis 10 illustrated in FIG. 1 is a rear wheel drive chassis, the present invention is equally intended and adapted for use with front wheel drive and four wheel drive vehicles.

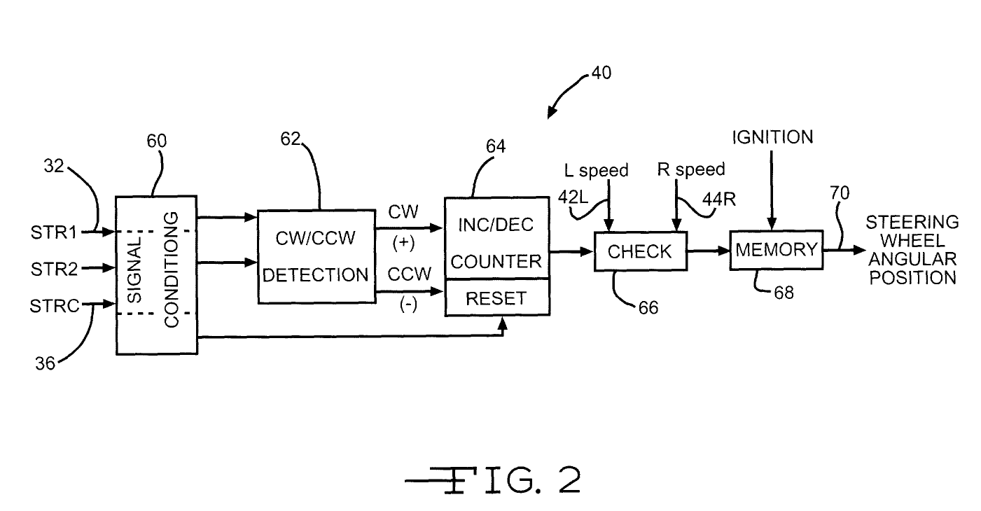

Referring now to FIG. 2, the pulsing electronic signals STR 1, STR 2, and STR C in the lines 32, 34 and 36, respectively, are provided to a signal conditioning module 60 which shapes and improves the signal pulses, if necessary, to ensure their accurate detection and counting in subsequent electronic components. The need for such conditioning is generally inversely proportional to the quality of the output signals of the angular velocity sensor 30. For example, Hall effect sensors have been found to provide relatively crisp and clean pulse signals whereas, for example, variable reluctance sensors, particularly at slower speeds, tend to generate less well defined pulse shapes than the essentially square waveforms illustrated. The tone wheel 24 and the angular velocity sensor 30 may be one of the magnetic types just described or may be optical or opto-electronic or other sensor and wheel combinations capable of generating well defined pulses in response to rotational movement of the steering column 20 which will generally be relatively slow and of a limited angular excursion in comparison to many rotary speed and position sensing applications. As noted above, if the signals from the sensor 30 are clean and with good definition, the signal conditioning module 60 may be unnecessary.

From the signal conditioning module 60, the signals STR 1 and STR 2 are provided to a clockwise/counterclockwise detection module 62. The clockwise/counterclockwise detection module 60 determines whether the pulse trains STR 1 and STR 2 in the lines 32 and 34, respectively, should be interpreted as indicating clockwise or counterclockwise motion of the steering column 20. When the angular motion of the steering column 20 has been properly interpreted, signals from the detection module 62 which represent either an incremental clockwise motion or an incremental counterclockwise motion, are provided to an increment/decrement counter module 64.

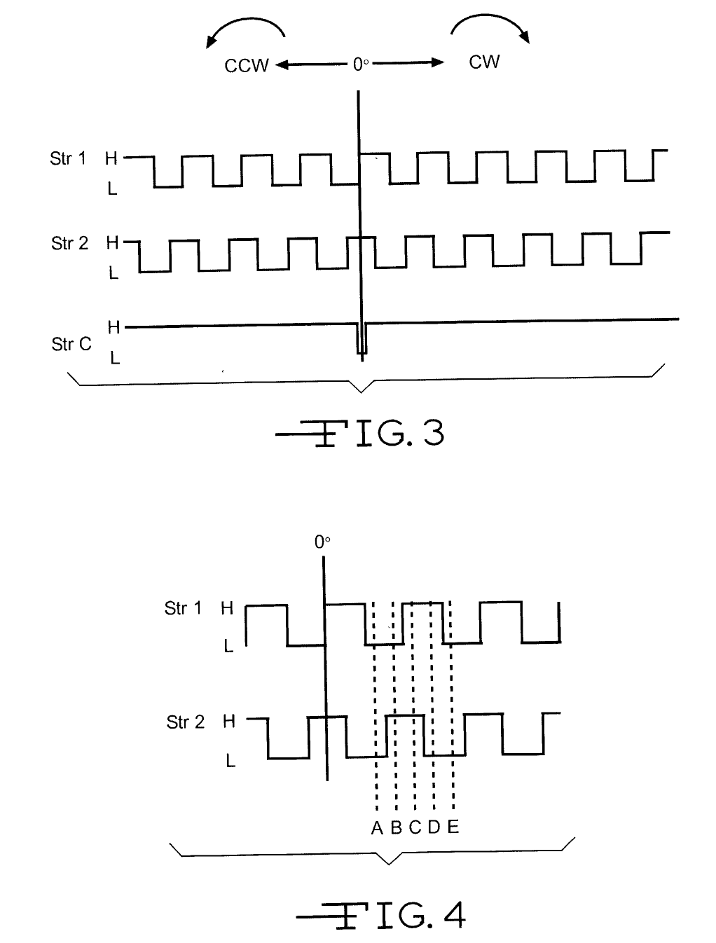

Referring now to FIG. 3, the operation of the clockwise/counterclockwise detection module 62 will be described in detail. As illustrated, the rotary or angular velocity sensor 30 provides a first stream or train of pulses STR 1 in the line 32 and a second stream or train of pulses STR 2 in the line 34. Preferably, the pulse trains operate at and define conventional logic high (H) and logic low (L) signal states. The two streams or trains of pulses are arranged in quadrature, that is, they are offset by 90° from one another as illustrated in FIG. 3. Thus, while both streams of pulses will include substantially the same number of pulses and leading and trailing edges representing a defined rotation of the steering column 20 and steering wheel 22, the leading and trailing edges of the pulses will be offset or out of phase by 90°. Equivalence between the number of pulses in the lines 32 and 34 may be utilized to provide a check on the operation of the system, if desired.

The third signal STR C in the line 36 is logic high (H) at all angular positions of the steering column 20 and the steering wheel 22 except at dead center or 0° of rotation at which location it drops to logic low (L) as a positive indication that the steering column 20 and the steering wheel 22 are at or are passing through their straight ahead (0°) position or angular orientation. This also provides a check or parity information to the system to reset the counter in the increment/decrement counter module 64 when the steering column 20 and the steering wheel 22 pass through the known, dead center or 0° rotation position.

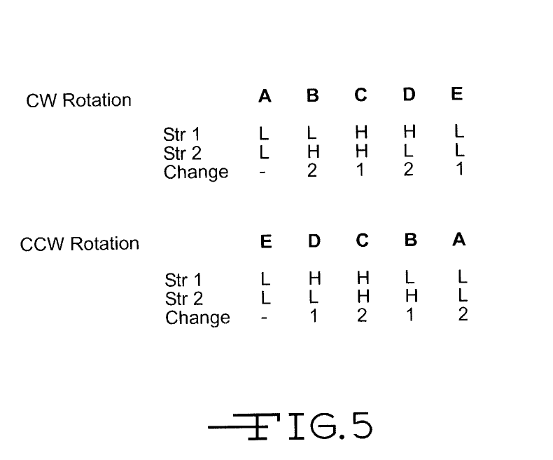

With reference now to FIG. 4, in order to determine the direction of rotation from the offset pulse trains or signals STR 1 and STR 2, it is necessary to detect the identity of the leading or trailing edges which effects a change of state of the pulse trains. For purposes of explanation, five angular positions, A, B, C, D and E are superimposed on the pulse trains STR 1 and STR 2. The clockwise/counterclockwise detection module 62 senses whether the change of state (H to L or L to H) is in the pulse train STR 1 or STR 2.

With reference now to FIG. 5, the detection or determination of clockwise or counterclockwise rotation by the detection module 62 will be illustrated. As the steering column 20 and steering wheel 22 rotate clockwise and the sensor 30 provides an output representative of the five adjacent angular positions A, B, C, D, and E, illustrated in FIG. 4, the states of the outputs STR 1 and STR 2 are presented in the upper portion of FIG. 5 under the heading CW or clockwise rotation. It will be appreciated that the states high (H) and low (L) of the signals STR 1 and STR 2 at the five locations A, B, C, D, and E correspond to distinct locations on the wave forms illustrated in FIG. 4. This signal information, i.e., a state of H or L, alone, will not permit determination of the direction of rotation of the steering column 20 and steering wheel 22. However, being provided with the added information of which signal or pulse train, STR 1 or STR 2 has changed state between two adjacent positions such as position A and position B, the detection module 62 can determine the rotation. This ability is illustrated by the unique codes generated at each of the five positions A, B, C, D, and E in the upper portion of FIG. 5.

Correspondingly, counterclockwise or CCW rotation from position E, through position D, position C, position B and back to position A provides the data presented in the lower portion of FIG. 5 under the heading CCW (counterclockwise) rotation. Once again, the information at the various positions E through A is unique as will be apparent by comparison of the two data presentations.

The two outputs of the clockwise/counterclockwise detection module 62, namely either a clockwise pulse or a counterclockwise pulse, are then utilized to increment or decrement the increment/decrement counter module 64. The accuracy of the signal is improved whenever, as noted above, the steering column 20 and the steering wheel 22 passes through the 0° or straight ahead orientation at which time the signal STR C is provided to a reset portion of the increment/decrement counter module 64 to override or reset whatever position determination has been made previously.

The output of the increment/decrement counter module 64 is then provided to a check or comparator module 66 which receives signals from the left and right front speed sensors 42L and 42R respectively in the lines 44L and 44R. Because these signals will be equal when the vehicle is traveling straight ahead or will be unequal if the vehicle is turning a corner, these speed signals can be and are utilized to provide an additional check or comparison with regard to the computed angular position provided by the increment/decrement counter module 64.

The output of the check or comparator module 66 is then provided to a memory module 68 which continuously updates and stores the current angular steering position and provides it to those electronic systems in the vehicle requiring this information. The memory module 68 is desirable so that when the vehicle ignition is turned off, the module 68 stores the current angular position of the steering column 20 and steering wheel 22. When the ignition is re-energized, the memory module 68 provides a signal in the line 70 representative of the current angular position of the steering column 20, the steering wheel 22, or the front tire and wheel assemblies 12 to those electronic systems of the vehicle requiring this information.

It should be appreciated that during the entire foregoing description, reference has been made to the angular position of the steering column 20 and the steering wheel 22. This is primarily for convenience and clarity inasmuch as it is apparent that the sensor 30 will directly sense the rotation of the tone wheel 24 which is fixedly secured to the steering column 20 and the steering wheel 22. However, it should be understood that the signal may be equally and wholly representative of the pivoting angular position of the front (steering) tire and wheel assemblies 20 but for the rotational or angular relationship between the steering column 20 and the front tire and wheel assemblies 20 as established by the linkage 14 and the steering box 16. Depending upon the requirements of the associated electronic equipment and processors to which the steering angle position signal is provided, the signal may be in positive and negative degrees of the steering column 20 and steering wheel 22 position or positive and negative degrees of the angular position of the front tire and wheel assemblies 12 or other configurations or scales which all may be converted and supported by appropriate electronic scaling and computation.

It should also be appreciated that whereas the foregoing description has, primarily for the purposes of clarity and illustration, referenced rotation of the steering column 20, the steering wheel 22 and pivoting of the front tire and wheel assemblies 12 as being either counterclockwise and of a negative value from a 0° or center straight ahead position and clockwise and therefore positive, again from a 0° or center straight ahead position, the electronic components may be readily recalibrated, and the present invention comprehends, an electronic computation unit 40 which begins with a 0 or nil signal at full left or full right travel of the steering column 20, the steering wheel 22 and the front tire and wheel assemblies 12 and increases (or decreases) typically uniformly as the steering column 20 and the steering wheel 22 rotate and the front tire and wheel assemblies 12 pivot toward the opposite direction, up to a maximum predetermined value representing the opposite end of rotational or pivoting travel with a center or 50% value representing the straight ahead position of the steering column 20, the steering wheel 22 and the front tire and wheel assemblies 12.

Lastly, it will be appreciated that the foregoing components, particularly the rotary or angular velocity sensor 30, the clockwise/counterclockwise detection module 62 and the increment/decrement counter module 64 operate as an integrator which integrates the velocity signals from the sensor 30 into the angular position of the steering column 20, the steering wheel 22 and the front tire and wheel assemblies 12. Stated somewhat differently, the outputs of the rotary or angular velocity sensor 30, particularly STR 1 and STR 2, which are a series of pulses, are integrated to generate a signal which does not represent velocity but rather represents the integral of velocity, which is position, and in this case, the angular position of the steering column 20 and the steering wheel 22. Once again, and as noted above, suitable computational ratios or factors may be utilized if it is desired to have the output of the assembly 30 represent the angular position of the front tire and wheel assemblies 12. In fact, the choice of the output, representing either angular position of the steering column 20 and steering wheel 22 which may range from approximately one and one-half turns counterclockwise to one and one-half turns clockwise for a total rotational excursion of approximately 1080° or the angular position of the front tire and wheel assemblies 12 which may vary from counterclockwise approximately −30° to −40° to clockwise approximately +30° to +40° for a total angle of excursion between about 60° and 80° is, in fact, entirely a matter of choice of scaling of the numerical values in order to render the output signal compatible and most readily adaptable and usable by associated electronic processors and systems within the motor vehicle.

The foregoing disclosure is the best mode devised by the inventor for practicing this invention. It is apparent, however, that apparatus and methods incorporating modifications and variations will be obvious to one skilled in the art of angular position sensing systems. Inasmuch as the foregoing disclosure is intended to enable one skilled in the pertinent art to practice the instant invention, it should not be construed to be limited thereby but should be construed to include such aforementioned obvious variations and be limited only by the spirit and scope of the following claims.

1. A method of determining an angular position of a vehicle steering component comprising the steps of:
providing a rotary velocity sensor disposed in sensing relationship with a rotating member of a vehicle steering assembly, said sensor having velocity and center position outputs;
determining the angular position of said rotating member from said velocity output; and
resetting said angular position to center when said sensor provides an output indicating said rotating member is in a center position.

2. The method of sensing an angular position of a vehicle steering component of claim 1 further including the step of sensing speeds of a pair of front vehicle wheels and resetting said angular position to center when said sensed speeds of said pair of wheels are equal.

3. The method of sensing an angular position of a vehicle steering component of claim 1 wherein said determining step includes determining the direction of rotation of said rotating member.

4. The method of sensing an angular position of a vehicle steering component of claim 1 wherein said determining step includes determining the angular rotation of said rotating member.

5. The method of sensing an angular position of a vehicle steering component of claim 1 wherein said determining step includes determining the direction and magnitude of rotation of said rotating member.

6. The method of sensing an angular position of a vehicle steering component of claim 1 further including the step of providing a tone wheel on said rotating member proximate said rotary velocity sensor.

7. The method of sensing an angular position of a vehicle steering component of claim 1 further including the step of storing said angular position when an ignition system of said vehicle is de-energized.

8. A method of sensing an angular position of a vehicular steering component comprising the step of:
providing a rotary velocity sensor having an output;
positioning such rotary velocity sensor assembly in sensing relationship with a vehicular steering component;
providing said output of said rotary velocity sensor assembly to an integrator; and
integrating said output to provide a signal representing the angular position of said steering component.

9. The method of sensing an angular position of a vehicular steering component of claim 8 further including the step of sensing speeds of a pair of front vehicle wheels and resetting said angular position to center when said sensed speeds of said pair of wheels are equal.

10. The method of sensing an angular position of a vehicular steering component of claim 8 wherein said integrating step includes determining the direction of rotation of said rotating member.

11. The method of sensing an angular position of a vehicular steering component of claim 8 wherein said integrating step includes determining the angular rotation of said rotating member.

12. The method of sensing an angular position of a vehicular steering component of claim 8 wherein said integrating step includes determining the direction and magnitude of rotation of said rotating member.

13. The method of sensing an angular position of a vehicular steering component of claim 8 further including the step of providing a tone wheel on said vehicular steering component proximate said rotary velocity sensor.

14. The method of sensing an angular position of a vehicular steering component of claim 8 further including the step of storing said angular position when an ignition system of said vehicle is de-energized.

15. An apparatus for determining an angular position of a steering component of a motor vehicle comprising, in combination;
a rotary velocity sensor disposed in sensing relationship with a rotating component of a vehicular steering system, said sensor having velocity and center outputs;
means for determining the magnitude and direction of rotation of said steering component from said velocity output means and providing an output representing an angular position of said steering component; and
means for resetting said angular position when said center output indicates said rotating steering component is at center position.

16. The apparatus for determining an angular position of a steering component of a motor vehicle of claim 15 further including means for storing said angular position of said steering component when an ignition system of said vehicle is deenergized.

17. The apparatus for determining an angular position of a steering component of a motor vehicle of claim 15 further including a tone wheel disposed on said rotating component proximate said rotary velocity sensor.

18. The apparatus for determining an angular position of a steering component of a motor vehicle of claim 15 further including a speed sensor on each front wheel of said motor vehicle and a speed comparator for comparing speeds of said front wheels and providing a signal indicating straight ahead vehicle motion when said speeds are equal.

19. The apparatus for determining an angular position of a steering component of a motor vehicle of claim 15 wherein said rotary velocity sensor provides two pulse train outputs and further including means for comparing the number of pulses in said two pulse train outputs.

20. The apparatus for determining an angular position of a steering component of a motor vehicle of claim 15 wherein said rotary velocity sensor provides a pair of pulse train outputs in quadrature.
